(19) United States
(12) Patent Application Publication
(10) Pub. No.: US 2007/0089239 A1
(43) Pub. Date: Apr. 26, 2007

(54) Surgical fixture device and method for supporting a patient during surgery

(76) Inventor: Leo A. Whiteside, Chesterfield, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/516,280

(22) Filed: Sep. 6, 2006

Related U.S. Application Data
(60) Provisional application No. 60/729,560, filed on Oct. 24, 2005.

(51) Int. Cl. A61G 13/12

(52) U.S. Cl. 5/624; 5/621

(57) ABSTRACT

A hip positioner for hip surgery (e.g., total hip arthroplasty surgery) is disclosed in which the patient is in a lateral position with the hip upon which surgery is to be performed facing upwardly. The patient lies on a support board having a plurality of holes therein with pins inserted in selected ones of these holes so as to prevent the patient from rolling on to the patient's back. A stanchion is inserted in at least one of the holes on the front of the patient at or above the level of the patient's hips and a support arm extends horizontally from the stanchion toward the upper hip. A pad is carried on the distal portion of the support arm for positive engagement with a desired anatomical feature of the patient (preferably the crest of ilium of the patient's upper hip) thereby to hold the patient in such desired lateral position during surgery.

### CROSS-REFERENCE TO RELATED APPLICATIONS PRIORITY CLAIM

This application claims priority to U.S. provisional application filed Oct. 24, 2005 having Ser. No. 60/729,560, the provisional application being incorporated herein to the extent permitted by law.

### STATEMENT REGARDING FEDERALLY SPONSORED RESEARCH OR DEVELOPMENT

Not Applicable.

### BACKGROUND OF THE DISCLOSURE

This disclosure relates to a fixture used to support a patient during surgery. In particular, the disclosure relates to a hip positioner fixture used to hold a patient on his or her side (i.e., in a lateral position) during hip arthroplasty surgery.

In hip surgery, the patient is typically positioned on his or her side with the hip upon which surgery is to be performed facing upwardly so as to present an unobstructed operating area for the surgeon. A wide variety of prior art hip positioners have been used in the past. In general, these prior art hip positioners utilized various fixtures adjustably secured to the operating table in front and in back of the patient so as hold the patient on his or her side. Because these prior art positioner fixtures were fastened to the edge of the operating table, this required the use of a large, adjustable structure, which often lacked the necessary rigidity to fixedly hold larger and heavier patients.

Also, certain other prior art hip positioners again used a support fixed to the edge of the operating table with structure extending from the support toward the patient with a vertical post extending upwardly from the operating table nearer the patient so as to adjustably support a hip support bracket that engaged the front of the patient's upper and lower hips. These prior art hip positioners did not readily accommodate a wide variety of size and height dimensions for patients. Further, the prior art hip positioners were necessarily positioned in front of the patient's hips and interfered with the operating field and/or with the surgeon's access to the operating field, especially the field in front of the patient.

Another type of prior art hip positioner utilized a board placed on the operating table, where the board was clamped or otherwise secured to the operating table. The board was of a thick (e.g., 1.0 inches), rigid material, such as a suitable plastic (e.g., polypropylene), having a pattern of holes therein. Typically, these holes were uniformly arranged in rows with the holes in one row being offset from the holes in the next adjacent row. For example, one such board is illustrated in FIG. 1 of the drawings and was commercially available from Whiteside Biomechanics, Inc. of St. Louis, Miss., and was about 20 inches wide and about 48 inches long. This board had some 377 holes with the holes spaced 2 inches on center with the holes of the next row offset 1 inch from holes of the adjacent rows. The diameter of these holes was relatively large (e.g., 0.945 inches).

A plurality of pins or pegs of various lengths were provided where the bottom ends of the pins fit snugly within a selected hole in the board such that the pins may be readily manually inserted and removed in a selected hole. The lower ends of these pins were smaller than the diameter of the main body of the pin such that the lower ends snugly fit in a respective hole. Furthermore, a shoulder bears on the upper face of the board surrounding the hole so that the pin will rigidly resist substantial side loading. A gel pad was placed between the board and the patient so as to better distribute the patient's weight on the board and to lessen trauma to the unoperative side of the patient.

In use, this pad was placed on the board and a draw sheet was placed over the gel pad so as to keep the gel pad in place as the patient was transferred onto the operating table. Initially, the patient was placed on the gel pad and on the board in the supine position. After the patient was anesthetized, the patient was lifted and turned so as to be in the desired lateral position with the patient's hip upon which surgery was to be performed facing upwardly. So-called stay pins were placed into selected holes of the support board in close proximity to the patient's sacral area. A short pin was placed just to the front of the patient's pubic area. The longer pin was positioned in close proximity to the patient's posterior thoracic region in the region below the scapula. The longer pins were preferably placed along the anterior thoracic area.

However, with all such prior art pin hip positioning systems, it was difficult to support obese patients because of the soft condition of the patient's abdominal and anterior and posterior thoracic regions. Oftentimes, once the patient was positioned, the patient would shift during surgery because the hip positioner could not positively hold the patient in the desired lateral position. In certain instances, the patient required re-positioning during the surgery. The pubis region area provides insufficient support because it was often covered with a thick layer of fat. Further, the pubis area lies near the femoral artery, nerve and vein so the shifting allowed these structures to be compressed and possibly damaged by the pubic pin.

Medical personnel require a support fixture that engages a prominent anatomical skeletal feature that is readily found on most patients, regardless of age or size, wherein this anatomical feature needs to be substantially free of soft tissue. Further, medical personnel require a support fixture that allows unobstructed access to the operative area from the front and rear of the patient. Additionally, medical personnel require a support fixture that provides fine adjustments of position to allow for differences in sizes and shapes of patients.

### SUMMARY OF THE DISCLOSURE

The present disclosure relates to a fixture used to hold a patient on his or her side (i.e., in a lateral position) during surgery. The present disclosure relates to fixture for holding a patient in a lateral position for hip surgery with the hip upon which surgery is to be performed facing upwardly, where the patient is lying on a support board having a plurality of holes, one or more pins insertable into selected ones of the holes of the support board along the posterior and anterior of the patient so as to at least in part hold the patient in the lateral position.

The fixture comprises a vertically extending stanchion fixedly positioned in front of the patient. The stanchion has a bottom end being receivable in at least one of the selected holes of the support board to position the stanchion above the level of the patient's hips. The fixture also comprises a support arm adjustably connected to the stanchion. The support arm extends toward the patient's upwardly facing hip upon which surgery is to be preformed. Additionally, a pad connects to a distal portion of the support arm. The pad is engageable with the patient's crest of ilium thereby to hold the patient in position for hip surgery.

Additionally, the present disclosure relates to a method of supporting a patient in a lateral position for hip surgery with the hip upon which surgery is to be performed facing upwardly, where the patient is lying on a support board having a plurality of holes, one or more pins insertable into selected ones of the holes in the support board along the posterior and anterior of the patient so as to at least in part hold the patient in the lateral position. The method comprises inserting a stanchion into at least one of the holes of the support board and adjustably moving a support arm that is connected to the stanchion in a direction toward the patient's upwardly facing hip. The method further comprises engaging a pad that is carried on a distal portion of the support arm with the patient's crest of ilium thereby to hold the patient in position for hip surgery.

Other advantages, objects and features of this disclosure will be in part apparent and in part pointed out hereinafter.

### BRIEF DESCRIPTION OF THE SEVERAL VIEWS OF THE DRAWINGS

FIG. 1 is a perspective view of a prior art support board having a plurality of holes therein arranged in rows and showing various support pegs that may be manually inserted into and removed from selected holes to support both anteriorly and posteriorly areas of a patient lying on the support board to hold the patient in a desired lateral position with the uppermost hip exposed for hip surgery;

FIG. 2 is a perspective view of a fixture constructed in accordance with and embodying the present disclosure, a stanchion of the fixture being directly insertable in holes of the support board of FIG. 1, so as to be positioned relative to the patient resting in the desired lateral position on the support board where the stanchion is generally above the level of the patient's waist with an adjustable support arm engageable with the patient's desired anatomical (preferably the crest of ilium) of the upwardly facing hip so as to hold the patient on such lateral position;

FIG. 3 is a perspective view of a portion of a patient (shown in phantom) lying in a lateral position on the support board with the support arm of FIG. 2 in engagement with the desired anatomical feature of the patient's upper hip thereby to firmly hold the patient's hip in the desired lateral position for hip surgery;

FIG. 4 is an exploded perspective view of the fixture illustrating various parts of the fixture constructed in accordance with and embodying the present disclosure; and

FIG. 5 is a flowchart illustrating steps of supporting a patient in accordance with the present disclosure.

Corresponding reference numerals will be used throughout the several figures of the drawings.

### DETAILED DESCRIPTION OF A PREFERRED EMBODIMENT

The following detailed description illustrates the disclosure by way of example and not by way of limitation. This description will clearly enable one skilled in the art to make and use the disclosure, and describes several embodiments, adaptations, variations, alternatives and uses of the disclosure, including what I presently believe is the best mode of carrying out the invention. Additionally, it is to be understood that the disclosure is not limited in its application to the details of construction and the arrangements of components set forth in the following description or illustrated in the drawings. As will be apparent to those skilled in the art of designing apparatus for supporting patients during hip surgery, the present disclosure is capable of other embodiments.

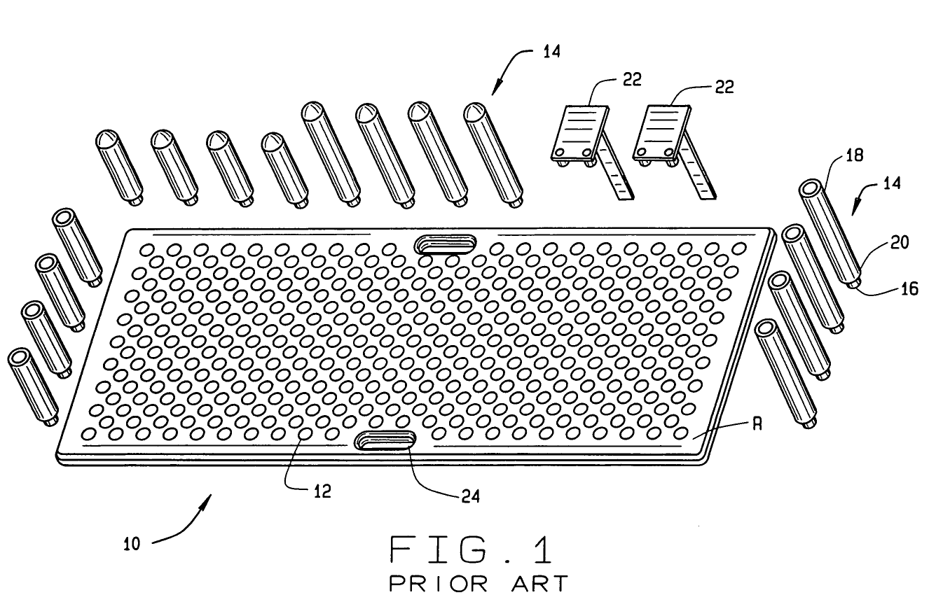

Referring now to the drawings, a prior art patient support board is indicated in its entirety at 10 in FIG. 1. The support board 10 comprises a flexible, but rigid material, such as but not limited to solid polypropylene, preferably having a thickness of about one inch. The support board has a plurality of holes 12 therein with the holes arranged in rows R where the holes in each row are spaced from one another at regular intervals (e.g., 2 inches) and with the rows are regularly spaced from one another at, regular intervals (e.g., 1 inch) with the holes in one row offset from the holes in adjacent rows. The holes 12 may, for example, have a diameter of about 0.945 inches. While the openings in the support board are described as circular cross section “holes”, it will be understood that other openings having other cross sections may be employed and that the openings need not extend through the thickness of the board 10. However, such circular cross section holes 12 extending through the board are preferred. A plurality of pins or pegs 14 are provided, each having a pin bottom end 16, which is adapted to be manually inserted in and removed from any particular hole 12, but which have a snug fit when inserted in the holes. Each of the pins 14 has a body 18 having a diameter somewhat larger than pin bottom end 16 such that a pin shoulder 20 is provided which bears on the upper surface of support board 10 when the pin bottom end 16 is inserted in a selected hole 12 whereby the pin shoulder resists side loads applied to the pins 14. Pins 14 may be manually inserted in and manually removed from holes 12 without the use of tools. Support board 10 is firmly clamped to an operating table (not shown) by mounting clamps 22, which are engageable with slots 24 in opposite sides of the support board.

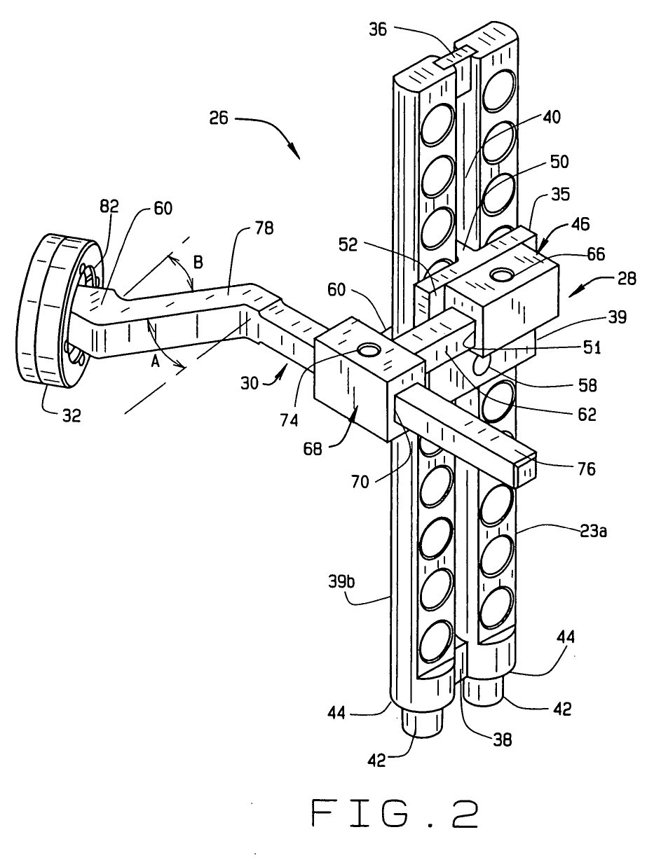

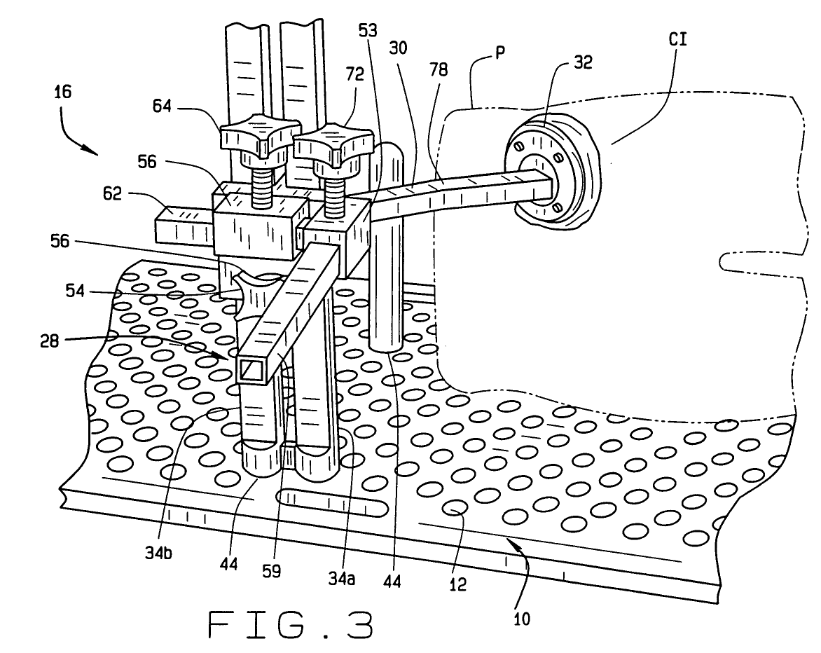

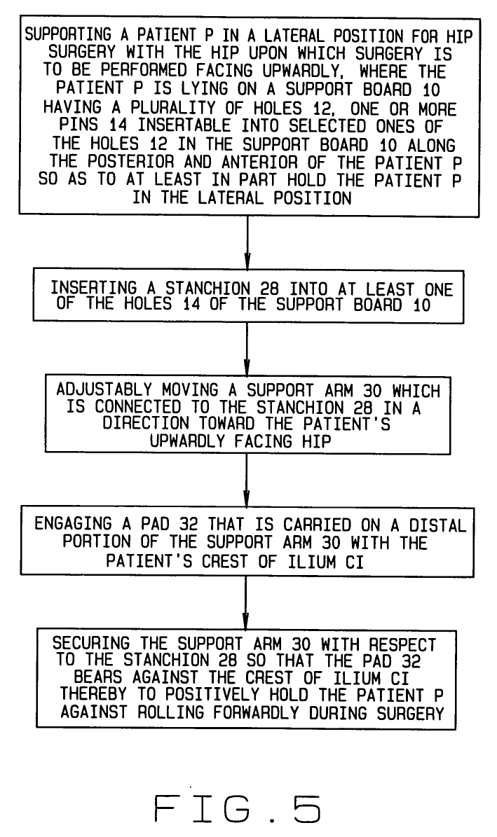

Referring now to FIGS. 2-5, one embodiment of a fixture 26 in the form of a hip positioner of the present disclosure is illustrated. This fixture 26 is capable to be used in conjunction with support board 10 (FIG. 1). The fixture 26 comprises a stanchion 28, a support arm 30 and a pad 32. Specifically, this fixture 26 comprises the vertically extending stanchion generally shown as 28, which is directly insertable in at least one of the selected holes 12 of support board 10 so as to permit rapid installation and removal of the stanchion and so as to enable operating room personnel to rapidly position the stanchion on the support board relative to patients P (FIG. 3) of varying heights and weights. As such, the stanchion 28 fixedly positions in front of the patient P via the selected holes 12. The stanchion 28 has a bottom end being receivable in at least one of the selected holes 12 of the support board 10 to position the stanchion above the level of the patients' hips.

The support arm 30 adjustably connects to the stanchion 28. The support arm 30 moves horizontally and vertically with respect to the stanchion 28. The support arm 30 extends towards the patient's upwardly facing hip upon which surgery is to be preformed. The pad 32 connects to a distal portion of the support arm 30 wherein the pad engages with the crest of ilium, as indicated at Cl in FIG. 3, (or engageable with such anatomical feature as the surgeon may choose) of the patient's upwardly facing hip. In one embodiment, the pad 32 comprises a padded cushion. The stanchion 28, support arm 30 and pad 32 firmly hold the patient P in the desired lateral position and prevent the patient from rolling forward during surgery. Further, since the stanchion 28 directly inserts into the selected holes 12 of board 10, the configuration of the stanchion 28, support arm 30 and the pad 32 provides the surgeon with an unobstructed operating region.

Turning to FIG. 3, with the patient P resting in a lateral position and with the patient being so held in this lateral position by pins (as previously described), stanchion 28 inserts into selected holes 12 in support board 10 so that the stanchion is spaced from the patient's abdominal region, preferably at or slightly above or below the level of the patient's hips, and even more preferably above or below the level of the patient's waist (i.e., the narrowed part of the body between the thorax and hips). As shown, the support arm 30 extends from stanchion 28 toward the patient's upper hip. As stated, when properly adjusted with respect to the patient P, pad 32 bears on the patient's crest of ilium Cl of the upper facing hip upon which surgery is to be performed. By so engaging the crest of ilium Cl, a solid anatomical feature is readily engaged by the pad 32 so as to firmly and positively prevent the patient P from rolling from the desired lateral position into an abdominal position. It will also be appreciated that regardless of the size and weight of a patient P, the crest of ilium Cl is easy to locate and there is a minimum of soft tissue overlying the crest of ilium such that pad 32 may solidly pressure on the crest of ilium thereby firmly holding the patient in such lateral position. Thus, the pad 32 engages a prominent anatomical skeletal feature that is readily found on patients, regardless of age or size of the patient, wherein this feature remains substantially free from soft tissue.

As shown in FIGS. 2-4, one embodiment of stanchion 28 comprises a pair of posts 34a, 34b joined in a desired side-by-side position by a pair of spacers 36 and 38 with a gap 40 defined between the posts. Each of the posts 34a, 34b has a respective bottom end 42 adapted to have a snug fit with holes 12 of support board 10 to fixedly position the posts 34a, 34b with respect to the support board 10 in the fixed space relation. It will be appreciated that the diameter of bottom ends 42 is similar to the diameter of pins 14 such that the stanchion 28 may likewise be readily insert in and remove from holes 12 by hand without the requirement of tools. A shoulder 44 is provided on the bottom of each post 34a, 34b above bottom ends 42 such that with the bottom ends fully inserted in hole 12 of board 10, the shoulder bears on the upper surface of the support board 10 in the area surrounding the hole into which each bottom end 42 is inserted. This shoulder 44 bears on the upper face of the support board 10 so as to aid in rigidly supporting the stanchion 28 and in resisting side loads, such as when pad 32 engages with the patient's crest of ilium Cl (or other anatomical feature) and when the patient tends to roll forward out of the desired lateral position. It will be appreciated that gap 40 is such that the bottom ends 42 of the side-by-side posts 34a, 34b may be readily inserted into any two adjacent holes 12 in any row R of holes of the support board 10.

As noted, support arm 30 readily adjusts in both vertical and horizontal directions with respect to posts 34a, 34b so that with the stanchion 28 installed in support board 10 in relation to patient P, pad 32 may be readily adjusted and brought into firm engagement with the crest of ilium Cl (or any other desired anatomical feature), and then the support arm may be readily clamped or otherwise locked relative to the stanchion in this desired supporting position. The support arm 30 adjusts in the vertical direction along the stanchion 28 so as to position the pad 32 in a desired vertical relation to the patient in order to pressure against the patient's crest of ilium. Additionally, the support arm 30 adjusts in the horizontal direction with respect to the stanchion 28 so as to move toward and away from the stanchion in line with the patient's axis in order to position the pad 32 to pressure against the patient's crest of ilium.

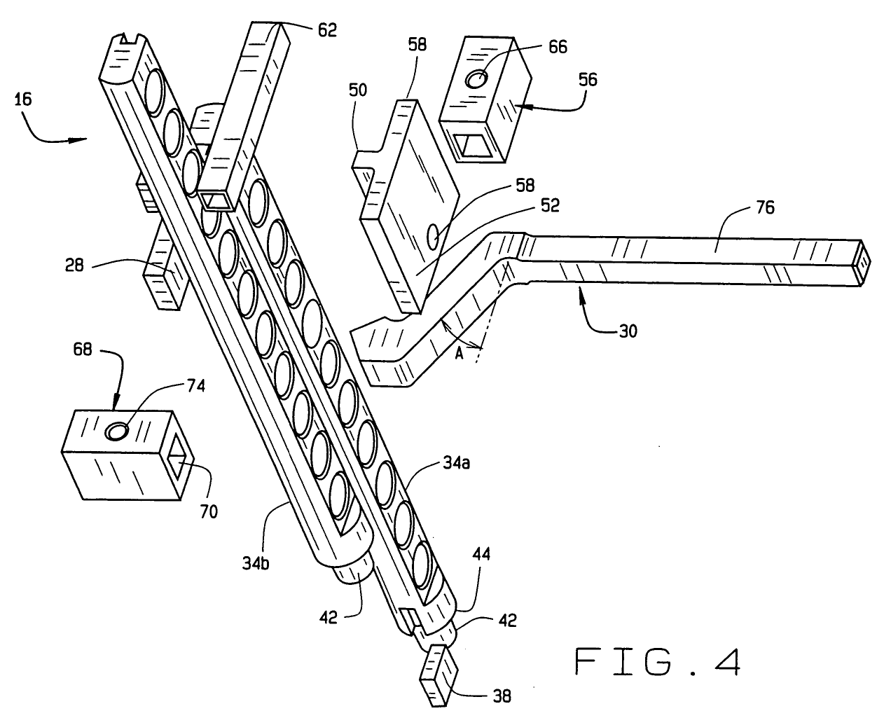

Specifically, a fixture socket 46 (FIG. 2) secures to posts 34a, 34b and objectively moves in the vertical direction relative to posts 34a, 34b. As shown in FIG. 4, fixture socket 46 includes a bracket 48 having a tab 50 and a base 52, where tab 50 is received within gap 40 between posts 34a, 34b for guiding the bracket as the support arm 30 is vertically adjusted. A screw clamp 54 (shown in FIG. 3) secures bracket 48 with respect to posts 34a, 34b in any desired adjusted position. The screw clamp 54 includes a hand adjustable clamp screw 56 inserted in a hole 58 (FIG. 4) defined through base 52, wherein screw clamp 54 engages a threaded hole (not shown) in a backing plate 60 (FIG. 2) on the back side of the posts 34a, 34b so as to forcefully clamp the posts between backing plate 60 and base 52. Thus, the bracket 48 (along with support arm 30) may be rigidly locked in any desired vertical position along at least a portion of the posts 34a, 34b.

Referring to FIG. 3, a bar 62 slidably receives within fixture socket 46 so as to be horizontally adjusted with respect to the posts 34a, 34b. A clamp screw 64 threadably engages threaded hole 66 (FIG. 4) defined through fixture socket 46 so as to lock bar 62 in any desired position along its length with respect to fixture socket 46. Bar 62 carries a support arm socket 68 on its distal portion. Support arm socket 68 has an opening 70 (FIG. 4) defined therethrough that slidably receives support arm 30 so that the support arm and the pad 32 carried on the distal portion of the support arm may be adjustably moved in horizontal direction toward and away from the patient P such that the pad 32 may be brought into a firm supporting position pressing on the patient's crest of ilium Cl. A clamp screw 72 threadably engages hole 74 (FIG. 4) defined through the support arm socket 68 for locking (clamping) the support arm 30 in a desired adjusted position with respect to the support arm socket. As such, the support arm is (within a limited range) infinitely adjustable in the vertical direction with respect to the stanchion and is infinitely adjustable (again within a limited range) in the horizontal direction with respect to the stanchion.

As shown in FIGS. 2 and 4, support arm 30 has two compound angles A and B that allow the stanchion 28 to be spaced from the patient P such that the stanchion is not in contact with the patient, but yet the angles allow the support arm 30 and pad 32 to be in firm engagement with the crest of ilium Cl of the patient's upper hip and provides an unobstructed operative field for the hip. More specifically, these compound angles A, B permit stanchion 28 to be positioned generally above the level of the patient's hips, and more preferably, at about the level of the patient's waist, so that the stanchion does not substantially block access to the patient's hip from the front during surgery when the patient P is in the desired lateral position. As shown in FIG. 2, support arm 30 has a proximal portion 76, an intermediate portion 78 and the distal portion 80. The support arm socket 68 slidably receives the proximal portion 76 while the intermediate portion 78 angles relative to proximal portion 76 at angle A, preferably ranging between about 30-60 degrees and more preferably being about 45 degrees. The distal portion 80 angles relative to intermediate portion 78 at angle B, preferably ranging between about 30-60 degrees and more preferably being about 45 degrees. In this manner, distal portion 80 and proximal portion 76 are generally parallel.

Referring to FIG. 3, the stanchion 28 is positioned adjacent to the patient's waist so that the support arm 30 angles from the stanchion toward the patient's upper hip where by the stanchion is substantially clear of the operative field and the patient's abdomen. However, those skilled in the art will recognize that a wide range of such angles may be used so as to accommodate personal preferences of the surgeon as to the location of the stanchion 28 relative to the operative field.

Returning to FIG. 2, support pad 32 has a frame 82 that is swivelably mounted on the distal portion 80 of support arm 30 so that when pad 32 is brought into firm engagement with the crest of ilium Cl of the patient's uppermost hip, the pad 32 will somewhat self-align so as to align with the patient's crest of ilium and so as to best transfer load from the support arm to the patient's hip. Preferably, pad 32 has an internal frame (not shown) that is swivelably mounted to the distal end of the support art 80, as noted above, and has a body of a suitable compressible material (e.g., a suitable elastomeric foam or solid material) carried by the frame such that the body of the pad better distributes the support load to the patient's crest of ilium Cl over a larger area of the hip thereby helping to minimize point loading and compression trauma on the tissue between the pad 32 and the crest of ilium during extended surgical procedures. Of course, the frame and the pad body may be covered by a suitable covering so as to allow it to be readily cleaned.

With the patient anthesized and with the patient lying in a lateral position on the patient's side with the hip upon which surgery is to be performed facing upwardly, pins 14 are inserted into corresponding holes 12 in support board 10 in close proximity to the patient's posterior as previously described so as to support the patient P against rolling onto the patient's back during surgery. In addition, one or more pins 14 are inserted in a selected hole 12 in board 10 so as to be positioned anteriorly of the patient just below the patient's pectoral muscle. With the patient P so positioned, stanchion 28 is positioned in front of the patient so that the support arm 30 is positioned generally above the level of the patient's hips and preferably at or somewhat above the level of the patient's waist. The bottom ends 42 of posts 34a, 34b are inserted in two adjacent holes 12 in support board 10 such that the shoulders 32 on the bottom ends of the posts bear firmly on the upper surface of the support board 10 and thus maintain the posts in an upright position even when a side load is placed on the posts as when the positioner exerts a force on the patient to hold the patient in the desired operating position.

The support arm 30 is adjustably moved in a direction toward the patient's upwardly facing hip. The fixture socket 46 is adjusted vertically with respect to posts 34a, 34b so that the support arm 30 is at the approximate level of the crest of ilium of the patient's upper hip. Clamp screw 64 is operated so as to lock the fixture socket 46 relative to the posts 34a, 34b in this desired vertical position. The proximal portion 76 of support arm 30 is adjusted horizontally via arm socket 68 so that pad 32 is brought into firm engagement with the crest of ilium Cl of the patient's upper hip so as to prevent the patient from rolling onto the patient's abdomen during surgery. With the support pad 32 so bearing on the patient's crest of ilium, clamp screw 56 is tightened so as to lock (clamp) the support arm 30 in this adjusted position with respect to socket 53 and thus to stanchion 28.

Because stanchion 28 is preferably positioned above the level of the patient's hips and even more preferably at the level of the patient's waist, and because support arm 30 is angled inwardly toward the uppermost hip, the stanchion and the support arm are positioned in such manner that they are substantially clear of the operative field; thus, allowing the surgeon and other operating room personnel relatively free access to the operative field from the front of the patient. The pad 32 bears on the crest of ilium, wherein this anatomical feature is readily located on patients of widely varying anatomies (i.e., heights and weights). It is particularly advantageous to employ the crest of ilium Cl as the anatomical feature utilized to support the patient P in such lateral position because even with obese patients, the crest of ilium is readily located. In addition, even with obese patients, there is typically only a minimum amount of tissue between the surface of the skin and the bony structure of the crest of ilium Cl. This in turn results in a solid support point for the pad 32, unlike prior hip positioning systems which relied on support members that engaged the relatively soft tissue of the patient's abdomen. In turn, this results in the fixture 26 of the present disclosure to more solidly support the patient P against rolling onto the patient's abdomen. While the support pad 32 is herein preferably described as being engageable with the crest of ilium Cl so as to support the patient P in the desired lateral position, it will be understood that the pad 32 may be used to engage other anatomical features of the patient, depending on the preference of the surgeon.

As shown, support arm 30 and bar 62 may comprise of square cross sections and the openings 70 and 66 in sockets 68 and 46, respectively may comprise square cross sections. It will be understood that these square cross section in the respective openings of their respective sockets aid in preventing rotation of the support arm 30 and the bar 62. It will also be recognized that if the patient P is positioned to face the opposite direction on support board 10 so that the patient's other hip is exposed for surgery, bar 62 may be removed from fixture socket 46 and inserted in the other end of opening 51, and support arm 30 may be removed from arm socket 68 and inserted from the opposite direction in arm socket 68 so that the patient may be held in a desired lateral position for surgery on the other hip.

As such, during use, the fixture of the present disclosure positively holds the patient in a desired lateral position throughout surgery. In particular, the stanchion of the fixture is placed well clear of the patient's hips and abdomen when the patient is in the desired lateral operating position. The support arm carried by the stanchion positions the pad against the patient's crest of ilium on the upwardly facing hip upon which surgery is to be performed so as to positively hold the patient in such lateral position independent of the size or shape of the patient.

The rigid stanchion is adjustably positioned relative to the patient by insertion of the lower end of the stanchion in holes provided in the support board so that the stanchion need not be fastened to the operating table. The fixture provides optimal hip exposure for the surgery and that does not substantially impede access to the operating area by the surgeon from the front of the patient. The pad engages the crest of the ilium such that little or no soft tissue is disposed between the pad and the crest of ilium thereby lessening the tendency of the patient to move from the desired lateral position, even during prolonged surgical procedures.

The fixture comprises a simple and rugged construction while being readily adjustable to accommodate a wide variety of patient shapes and sizes and thus permits patient specific positioning. Accordingly, the disclosure provides a support that allows fine positioning to allow for differences in sizes and shapes of the patients. Furthermore, the fixture is installable and removable without clamping to the operating table and without the necessity of special tools or fasteners.

As various changes could be made in the above constructions without departing from the scope of the disclosure, it is intended that all matter contained in the above description or shown in the accompanying drawings shall be interpreted as illustrative and not in a limiting sense.

1. A fixture for holding a patient in a lateral position for hip surgery with the hip upon which surgery is to be performed facing upwardly, where the patient is lying on a support board having a plurality of holes, one or more pins insertable into selected ones of the holes of the support board along the posterior and anterior of the patient so as to at least in part hold the patient in the lateral position, wherein the fixture, comprises:
A generally vertically extending stanchion fixedly positioned in front of the patient, the stanchion having a bottom end being directly receivable in at least one of the selected holes of the support board to position the stanchion above the level of the patient's hips;
a support arm adjustably connected to the stanchion, the support arm extending toward the patient's upwardly facing hip upon which surgery is to be preformed; and
a pad connected to a distal portion of the support arm, the pad being engageable with the patient's crest of ilium thereby to hold the patient in position for hip surgery.

2. A fixture as set forth in claim 1 wherein the support arm is adjustable in generally vertical direction along the stanchion so as to position the pad in a desired vertical relation to the patient so as to pressure against the patient's crest of ilium.

3. A fixture as set forth in claim 1 wherein the support arm is adjustable in the horizontal direction with respect to the stanchion so as to move toward and away from the stanchion in order to position the pad to bear against the patient's crest of ilium.

4. A fixture as set forth in claim 1 wherein the stanchion is positioned adjacent the patient's waist so that the support arm angles from the stanchion toward the patient's upper hip whereby the stanchion is substantially clear of the operative field and the patient's abdomen.

5. A fixture as set forth in claim 1 wherein the stanchion comprises a pair of vertical posts in side-by-side position, and wherein each post has a bottom end receivable in one of the respective holes in the support board thereby to fixedly position the posts with respect to the support board.

6. A fixture as set forth in claim 5 wherein the posts are spaced apart from one another with a gap therebetween, and are rigidly held in such fixed spaced relation.

7. A fixture as set forth in claim 6 further comprising a fixture socket securable to the posts wherein the fixture socket mounts the support arm to the stanchion in any desired position along at least a portion of the length of the posts.

8. A fixture as set forth in claim 7 further comprising an arm socket carried by said stanchion wherein the support arm is slidably receivable in the fixture socket, and wherein the support arm moves axially with respect to the arm socket so as to adjust the pad in a generally horizontal direction toward or away from the patient's hip, and wherein the arm socket has a clamp for locking the support arm in a desired position with respect to the stanchion.

9. A fixture as set forth in claim 8 further comprising a second socket carried by said stanchion and a bar slidably received in the second socket, said bar carrying the arm socket so that the support arm may be moved in generally vertical so as to position said pad in heightwise direction relative to the patient's upper hip, the second socket further having a clamp for adjustably securing the bar in a desired vertical fixed position relative to the stanchion so that the pad is engageable with the patient's upper hip.

10. A fixture as set forth in claim 1 wherein the support arm is infinitely adjustable within a limited range in generally vertical direction with respect to the stanchion, and wherein the support arm is infinitely adjustable within a limited range in generally horizontal direction with respect to the stanchion.

11. A fixture as set forth in claim 10 wherein the pad is set at a fixed angle so as to align with the patient's crest of ilium.

12. A fixture as set forth in claim 11 wherein the pad is swivelably carried by the support arm so as to self-align with the patient's crest of ilium when the pad is engageable with the patient's hip.

13. A support system for holding a hip surgery patient in a desired lateral position with the hip upon which surgery is to be performed facing upwardly, the system, comprising:
a support board having a plurality of holes therein, the holes being arranged in rows with the holes in each row being substantially equally spaced from one another and with the rows being spaced from one another at predetermined distances;
a plurality of support pins insertable in selected holes of the support board so that the pins are in close proximity to the patient's posterior thereby to prevent the patient from rolling onto the patient's back;
a stanchion insertable in at least one of the holes of the support board in front of the patient in a position adjacent and above the patient's hips with the stanchion clear of the patient; and
a support arm adjustably mounted to the stanchion, the support arm extending from the stanchion and extending toward the patient's upwardly facing hip upon which surgery is to be performed, the support arm being adjustable in both generally vertically and generally horizontally with respect to the stanchion so that a pad carried on a distal portion of the support arm is in firm contact with the patient's crest of ilium of the hip upon which surgery is to be performed thereby to hold the patient and to prevent the patient from rolling forward during surgery.

14. A surgical support as set forth in claim 13 further comprising at least one adjustable clamp for fixedly securing the support arm at a desired vertical position so the pad engages the patient's crest of ilium.

15. A surgical support as set forth in claim 13 wherein the stanchion has a pair of bottom ends for being received in two adjacent holes of the support board.

16. A surgical support as set forth in claim 15 wherein the stanchion has shoulders above the bottom ends with the shoulders bearing on the support board proximate the holes thereby to aid in supporting the stanchion in the support board and against side loads created by the patient.

17. A surgical support as set forth in claim 13 wherein the pad carried on the support arm comprises a compressible material so as to minimize the application of excessive compressive forces on the patient's tissue between the pad and crest of ilium thereby to minimize compression trauma to such tissue.

18. A surgical support as set forth in claim 13 wherein the stanchion is positioned on the support board above the level of the patient's waist with the support arm angling inwardly and posteriorly with respect to the patient for engagement of the pad with the patient's crest of ilium wherein the support arm is positioned to be clear of the patient's abdomen and to present a substantially unobstructed operative field for the hip.

19. A fixture for holding a patient in a lateral position for a medical procedure with the patient's body portion upon which the procedure is to be performed facing upwardly, where the patient is lying on a support board having a plurality of holes, one or more pins insertable into selected ones of the holes in the support board along the posterior and anterior of the patient so as to at least in part hold the patient in the lateral position, wherein the fixture, comprises:
a vertically extending stanchion fixedly positioned in front of the patient, the stanchion having a bottom end receivable in at least one of the selected holes of the support board to position the stanchion above the level of the patient's body portion;
a support arm adjustably mounted to the stanchion, the support arm extending toward the patient's body portion, the support arm being adjustable in vertical direction and horizontal direction with respect to the stanchion;
a pad connected to a distal portion of the support arm, the pad being engageable with an anatomical feature of the patient's; and
securement clamps that are selectively operable to as to fixedly lock said support arm with respect to said stanchion with the pad bearing against said anatomical feature body thereby to hold the patient in position for the procedure.

20. A method of supporting a patient in a lateral position for hip surgery with the hip upon which surgery is to be performed facing upwardly, where the patient is lying on a support board having a plurality of holes, one or more pins insertable into selected ones of the holes in the support board along the posterior and anterior of the patient so as to at least in part hold the patient in the lateral position, the method comprising:
inserting a stanchion into at least one of the holes of the support board;
adjustably moving a support arm which is connected to the stanchion in a direction toward the patient's upwardly facing hip;
engaging a pad that is carried on a distal portion of the support arm with the patient's crest of ilium; and
securing the support arm with respect to the stanchion so that the pad bears against the crest of ilium thereby to positively hold the patient against rolling forwardly during surgery.

21. The method as set forth in claim 20 wherein said step of adjustably moving the support arm comprises moving the support arm in generally vertical direction along the stanchion so as to position the pad in a desired vertical relation to the patient so that the pad bears against the patient's crest of ilium.

22. The method as set forth in claim 20 wherein said step of adjustably moving the support arm further comprises moving the support arm in generally horizontal direction with respect to the stanchion so as to move toward and away from the stanchion in order to position the pad to bear against the patient's crest of ilium.
